(19) United States
(12) Patent Application Publication
(10) Pub. No.: US 2010/0169708 A1
(43) Pub. Date: Jul. 1, 2010

(54) METHOD AND APPARATUS TO PROFILE RAM MEMORY OBJECTS FOR DISPLACMENT WITH NONVOLATILE MEMORY

(76) Inventors: John Rudelic, Folsom, CA (US); Jared Hulbert, Shingle Springs, CA (US); Jeffrey Wang, Pudong District (CN)

Correspondence Address: Gerbera/BSTZ;Blakely Sokoloff Taylor & Zafman LLP, 1279 OAKMEAD PARKWAY, SUNNYVALE, CA, 94085, US

(21) Appl. No.: 12/345,306

(22) Filed: Dec. 29, 2008

(51) Int. Cl. G06F 12/06; G06F 11/20

(52) U.S. Cl. 714/15; 711/159; 711/103; 711/E12.084; 711/E12.083; 714/E11.084

(57) ABSTRACT

A memory profiling system profiles memory objects in volatile memory and identifies memory objects as candidates to be stored and read directly from nonvolatile memory. The profiling system monitors memory accesses via page faults and identifies a memory object to be loaded in volatile memory. The profiling system uses page faults to determine a page fault type and a write frequency for the memory object, and determines the memory object's memory access type. The profiling system determines whether the object's memory access type meets the capabilities of the nonvolatile memory technology. If the memory access type meets the nonvolatile memory technology capabilities, the profiling system identifies the memory object as a candidate to be transitioned to and read directly from nonvolatile memory (e.g., NOR and PCM). The profiling system stores the memory object candidates in nonvolatile memory such that the memory objects are read directly from nonvolatile memory.

### FIELD

Embodiments of the invention relate to profiling volatile memory objects for displacement with nonvolatile memory. In particular, embodiments of the invention relate to identifying memory objects residing in random access memory as candidates for storing in and being read directly from nonvolatile memory and transitioning the candidate memory objects to nonvolatile memory.

### BACKGROUND

Many computer architectures structure memory as either (1) primary memory, which is volatile (meaning that the information is lost when the memory has no power), but relatively fast, such as random access memory (RAM), or (2) secondary memory, which is nonvolatile, but relatively slow, such as flash memory and a hard disk. Typically, original equipment manufacturers (OEMs) store persistent files to nonvolatile memory while creating and storing most other objects in RAM. For example, OEMs store code in flash memory and data in DRAM. Over time, however, OEMs have begun to store code in volatile memory and use a significant amount of DRAM. Many of the objects stored in DRAM can be transitioned to nonvolatile memory technology (e.g., NOR technology and phase change memory (PCM) technology) that can directly execute code. OEMs, typically lack the tools, however, to identify the memory objects stored in DRAM that can be stored in and read directly from nonvolatile memory.

### BRIEF DESCRIPTION OF THE DRAWINGS

Embodiments of the invention are illustrated by way of example and not limitation in the figures of the accompanying drawings, in which like references indicate similar elements and in which:

FIG. 1 shows a memory profiling system in accordance with one embodiment of the invention;

FIG. 2 illustrates a block diagram of a memory profiling system in accordance with one embodiment of the invention;

FIG. 3 is a flow diagram of one embodiment of a method for identifying a memory object stored in volatile memory as a candidate to be read directly from nonvolatile memory;

FIG. 4 is another flow diagram of one embodiment of a method for determining whether a memory object is a candidate to be stored and read directly from nonvolatile memory;

FIG. 5 is flow diagram of one embodiment of a method for determining a write frequency for a memory object; and

FIG. 6 is flow diagram of one embodiment of a method for determining whether a write frequency for a memory object meets a write frequency threshold.

### DETAILED DESCRIPTION

Embodiments of the invention provide a method and system for profiling memory objects that reside in volatile memory (e.g., RAM and DRAM) as candidates to be moved to and read directly from nonvolatile memory (e.g., NOR and PCM). The memory profiling system monitors memory accesses via page faults and identifies a memory object to be loaded in volatile memory. The profiling system uses page faults to determine a page fault type and a write frequency for the memory object, and determines the memory object's memory access type. The profiling system determines whether the object's memory access type meets the capabilities of the nonvolatile memory technology. If the memory access type meets the nonvolatile memory technology capabilities, the profiling system identifies the memory object as a candidate to be transitioned to nonvolatile memory (e.g., NOR and PCM). The profiling system stores the memory object candidates in nonvolatile memory such that the memory objects are read directly from nonvolatile memory. This method and system allows for improved performance by identifying memory objects that can be read directly from nonvolatile memory (e.g., NOR and PCM) rather than loaded and read from volatile memory (e.g., RAM and DRAM).

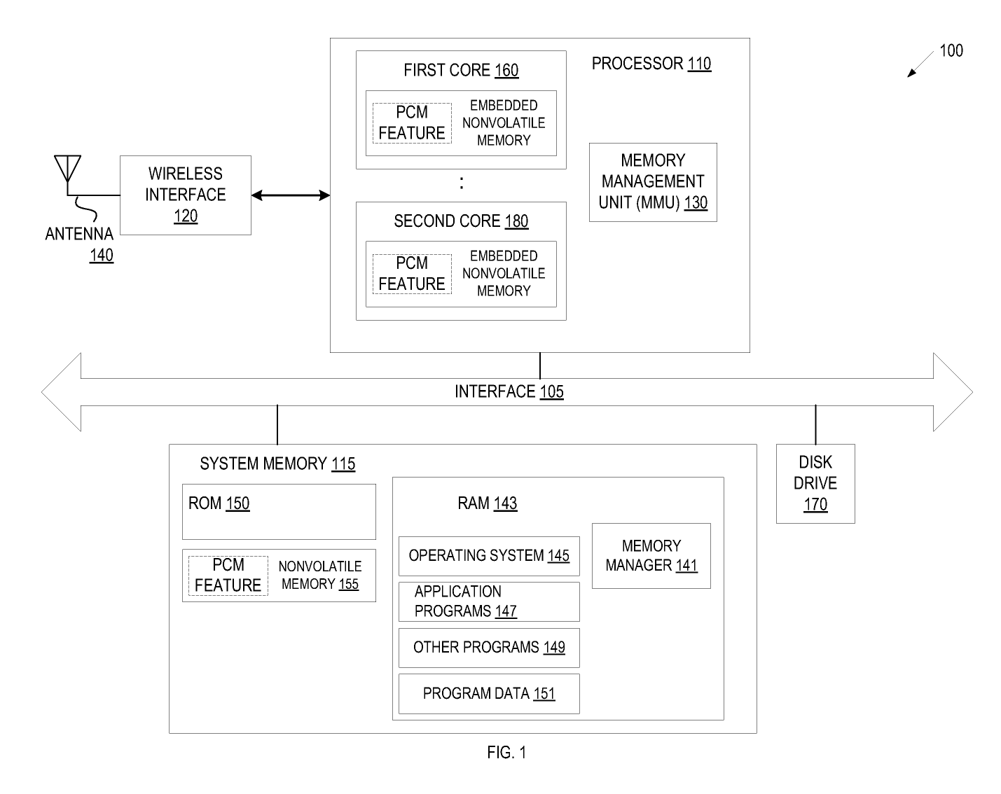

FIG. 1 shows a memory profiling system 100 in accordance with one embodiment of the invention. For one embodiment, the system 100 has a wireless interface 120. The wireless interface 120 is coupled to an antenna 140. The wireless interface 120 receives and transmits data and information. Embodiments are not, however, limited to wireless communication embodiments. Other non-wireless applications can use the embodiments of the invention.

The system 100 comprises a processor 110 coupled to interface 105. The interface 105 can be used to provide communication or information between the processor 110 and the memory storage in a system memory 115. Interface 105 may comprise serial and/or parallel buses to share information along with control signal lines to be used to provide handshaking between the processor 110 and system memory 115.

The system memory 115 can optionally be used to store instructions that are executed by the processor 110. System memory 115 can be provided by one or more different types of memory and may include both volatile (e.g., random access memory 143 (RAM) and dynamic random access memory (DRAM)) and a nonvolatile memory (e.g., read only memory 150 (ROM) and nonvolatile memory 155 having a phase change material). Examples of nonvolatile memory 155 include NOR flash memory, Phase Change Memory (PCM), Phase-Change Random Access Memory (PRAM or PCRAM), Ovonic Unified Memory (OUM) or Chalcogenide Random Access Memory (C-RAM). Examples of volatile memory 143 are RAM and DRAM. System memory 115 includes memory manager 141 to profile and transition memory objects in volatile memory to be read directly from nonvolatile memory.

RAM 143 typically contains data and/or program modules that are immediately accessible to and/or presently being operated on by processor 110. FIG. 1 illustrates operating system 145, application programs 147, other program modules 149, and program data 151. The volatile 143 and nonvolatile 150,155 memories can be combined in a stacking process to reduce the footprint on a board, packaged separately, or placed in a multi-chip package with the memory component placed on top of the processor. The embodiment also illustrates that one or more of the processor cores 160,180 may be embedded with nonvolatile memory.

For one embodiment, system 100 includes a processor 110 with an integral memory management unit (MMU) 130. In other embodiments, the memory management unit 130 is a separate chip. The memory management unit (MMU) 130 is a hardware device or circuit that is responsible for handling accesses to memory requested by the processor 110. The memory management unit 130 supports virtual memory and paging by translating virtual addresses into physical addresses. The memory management unit 130 divides the virtual address space (the range of addresses used by the process) into pages, each having a size which is a power of 2 (i.e., 2^{N}). The bottom N bits of the address (the offset within a page) are left unchanged. The upper address bits are the virtual page number.

The memory management unit 130 may include a small amount of memory (e.g., cache) that holds a table to translate virtual page numbers to physical page numbers. The table may be referred to as a translation look aside buffer (TLB) that matches virtual addresses to physical addresses. All requests for data are sent to the memory management unit 130, which determines whether the data is stored in volatile memory 143 or needs to be fetched from a mass storage device (e.g., a disk drive 170). If the data is not in any storage, the memory management unit 130 issues a page fault interrupt.

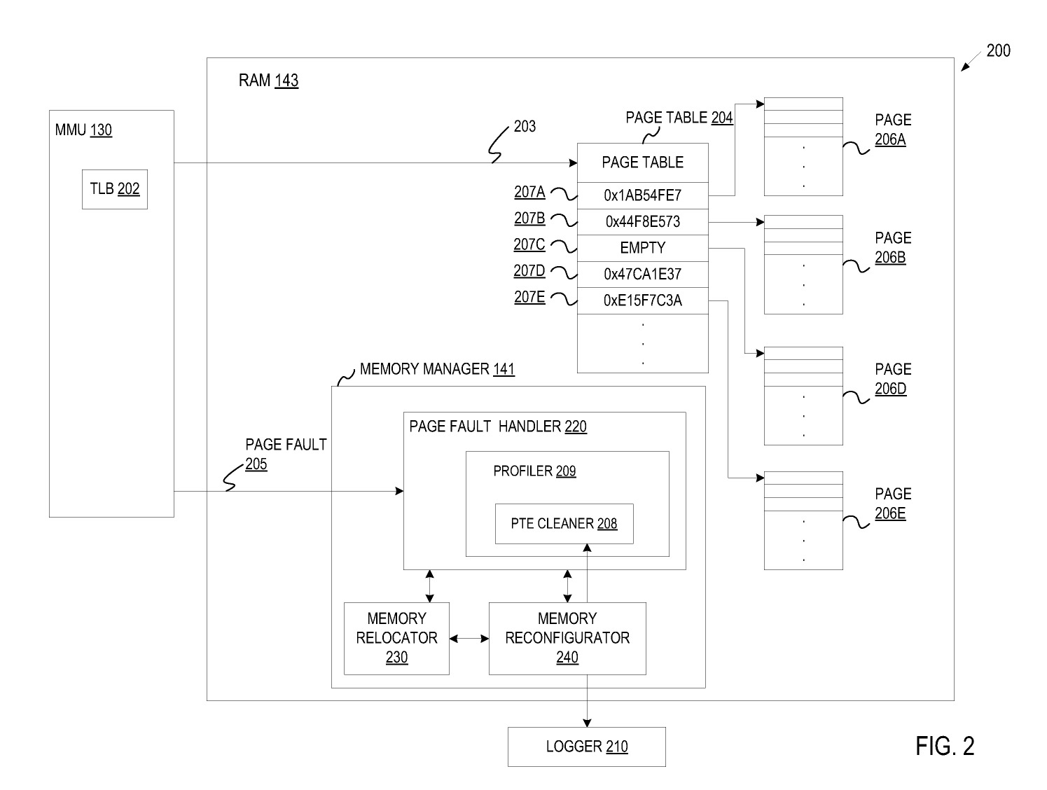

FIG. 2 illustrates a block diagram of a memory profiling system 200 in accordance with one embodiment of the invention. System 200 uses a page-type virtual address scheme and includes memory manager 141 to profile and transition memory objects in volatile memory to be read directly from nonvolatile memory. All requests for data are sent to the MMU 130, which determines whether a memory object is stored in volatile memory (e.g., DRAM). A memory object has a virtual address comprising a virtual page number and an offset with the page number. The MMU 130 typically translates virtual page numbers to physical page numbers via a translation look aside buffer 202 (TLB). For example, if a program is running and tries to access a memory object, the MMU 130 looks up the address within the TLB 202. If the MMU 130 detects a match for the virtual page within the TLB 202 (a TLB hit), the physical location is retrieved and the program can access the memory object. However, a TLB 202 may hold a fixed number of page translations and if the TLB 202 lacks a translation (a TLB miss), the MMU 130 accesses 203 a page table 204, a mechanism involving hardware-specific data structures.

A page table 204 contains page table entries 207A-E (PTEs), where each entry identifies a physical location of a page (206A, 206B, 206D, or 206E). Pages are defined-length contiguous portions of RAM 143 and may store any type of data. The page table entries 207A-E can also include information about whether the page (memory object) has been written to, when it was last loaded, what kind of processes may read and write it, and whether it should be cached.

If the MMU 130 does not find a valid entry for the virtual address in the page table 204, the MMU 130 generates a processor interrupt called a page fault 205 interrupt (or page fault). For instance, when a memory object is not available in DRAM, the MMU 130 finds there is no translation in the page table 204 (e.g., 207C) and the MMU 130 generates a page fault 205. When a page fault 205 occurs, the MMU 130 transfers control to the page fault handler 220.

The page fault handler 220 decides how to handle a page fault 205. The page fault handler 220 determines whether the virtual address is valid. If the virtual address is valid the page fault handler 220 finds an available page, places the memory object in that page, and updates the page table 204 with the translation. The page fault handler 220 instructs the MMU 130 to retry the operation. The MMU 130 retries the operation and the page (memory object) is loaded in volatile memory (e.g., DRAM).

The page fault handler 220 includes a profiler 209 to profile memory objects loaded in DRAM as candidates to be stored in and read directly from nonvolatile memory (e.g., NOR, PCM). The profiler 209 uses the page faults 205 to identity a memory object to be loaded in DRAM and monitors the page table activity to generate profiling data for determining whether a memory object is a candidate to be read directly from nonvolatile memory. Profiling data can include the address of the memory object, how often an object is loaded in DRAM, and how often the object is written to. The profiler 209 uses the profiling data to classify a memory object as a memory access type and determines whether the memory access type qualifies as a candidate for NOR or PCM memory. Table 1 illustrates four exemplary memory access types (e.g, “read only,” “read-write rarely,” “read-write,” and “read-write frequently”) qualifying as candidates for NOR or PCM technology.

TABLE 1

| | Candidate for | Candidate for |
|---|---|---|
| Memory Access Type | NOR? | PCM? |
| Read only | YES | YES |
| Read - write rarely | YES | YES |
| Read - write | NO | YES |
| Read - write frequently | NO | NO |

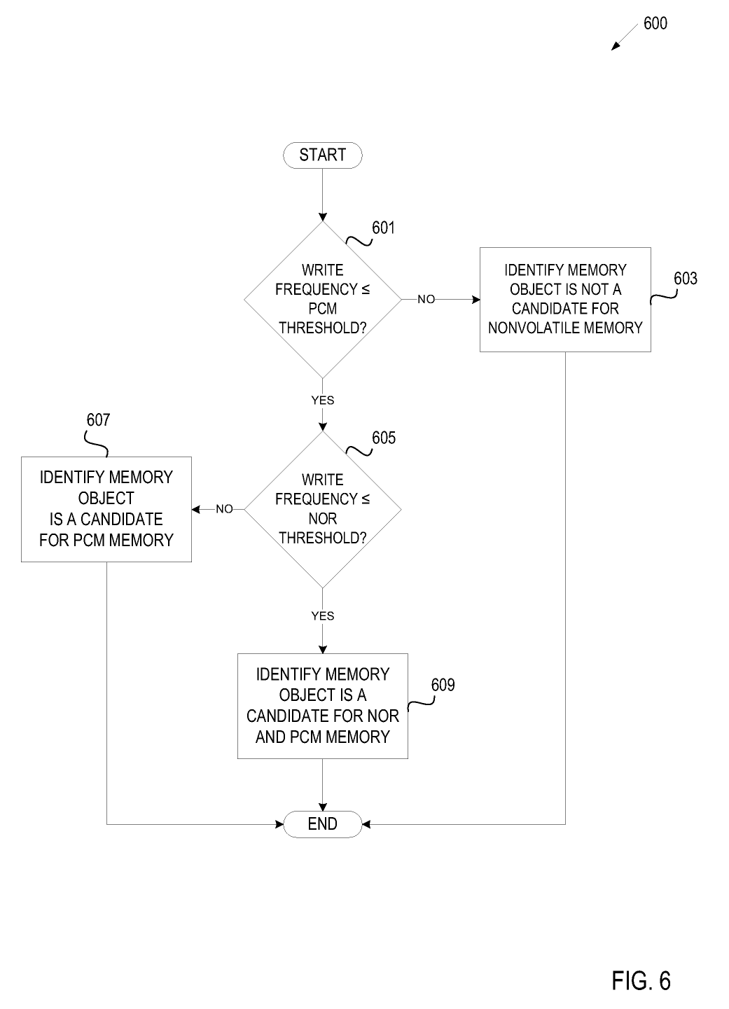

Ideal candidates include memory objects that are read only or read and rarely written to. The terms ‘rarely’ and ‘frequently’ are terms used in reference to the specific parameters of the type of memory technology in a system. FIG. 6 describes the memory access types in greater detail below.

The profiler 209 determines a memory object's memory access type by determining a memory object's write frequency. The profiler 209 monitors the page table activity for a period of time (profiling time period). The write frequency is the number of times a memory object was written to during the profiling time period. The profiler 209 determines a memory object's write frequency by logging a page fault 206 for a memory object each time a memory object is written to. The profiler 209 includes a page table entry (PTE) cleaner 208 to clean the page table entries of a page table. When a page is loaded, the PTE cleaner 208 re-marks the loaded page as not loaded. For one embodiment, the PTE cleaner periodically marks loaded pages as not loaded at a predefined time interval (e.g., 10 ms). Marking loaded pages as not loaded artificially cleans a page table 204 and forces a page fault when a memory object is requested which the profiler 209 can detect. The profiler 209 detects the page fault and determines whether the memory object was written to. The profiler 209 logs the number of times a memory object was written to.

For example, system 200 illustrates PAGE 206A and PAGE 206B. The profiler 209 determines that PAGE 206A was loaded a single time and had no write activity performed on it. Therefore, the profiler 209 classifies PAGE 206A as a read only memory access type. The profiler 209 determines that PAGE 206B was loaded once and written to one time during the profiling time period. Therefore, the profiler 209 classifies PAGE 206B as a read-write rarely memory access type.

The profiler 209 can output profile data as a raw data file that includes hex or binary information. For one embodiment, a logger 210 receives the profiler 209 output, creates a new memory map (e.g., memory configuration file), and automatically rebuilds the system memory according to the new memory map. Generally, pages (e.g., 206A-206E) are compressed before they are stored in nonvolatile memory. As a page is requested, an operating system will read a page out of the compressed image stored in nonvolatile memory, decompress it, and load the decompressed page in DRAM. The new memory map defines which pages to leave uncompressed before they are stored in nonvolatile memory such that the page is made available to be read directly from the nonvolatile memory and no longer loaded in DRAM. For example, if the profiler 209 identifies PAGE 206A as a read only memory access type, PAGE 206A is a candidate to remain in nonvolatile memory (e.g., PCM). A new memory map is created defining PAGE 206A to not be compressed in PCM, but to remain as an uncompressed image in PCM. Therefore, PAGE 206A is not loaded in DRAM, but is read directly from PCM the next time PAGE 206A is requested.

For another embodiment the logger 210 formats the profiling data generated by profiler 209 into a format a user is able to use to manually change a system's memory map and manually rebuild the system memory. The logger 200 receives the profiler output and maps it back to the specific pages (e.g., a particular data object, a particular file, a particular executable image, a particular database file, etc. and the offset within that file). The format may be a histogram that can illustrate which pages were frequently loaded and which pages were rarely loaded. A user can manually change a system's memory map and manually rebuild the system memory based on the data provided in the histogram.

For another embodiment, system 200 includes a memory reconfigurator 240 to dynamically reconfigure the system memory. The memory reconfigurator 240 automatically receives the output of the profiler 209 and identifies which pages should be stored in nonvolatile memory as uncompressed images. Using the output of the profiler 209, the memory reconfigurator 240 decompresses the identified pages and provides the information (e.g, new memory map) to a memory relocator 230.

The memory relocator 230 use the new memory map to interact with the page fault handler 220 to make memory objects available from NOR or PCM according to the new memory map. Using the example above, the memory relocator 230 detects a request for PAGE 206A is made, identifies PAGE 206A is an uncompressed image in PCM and instructs the page fault handler 220 to not load PAGE 206A in DRAM but to read PAGE 206A directly from PCM.

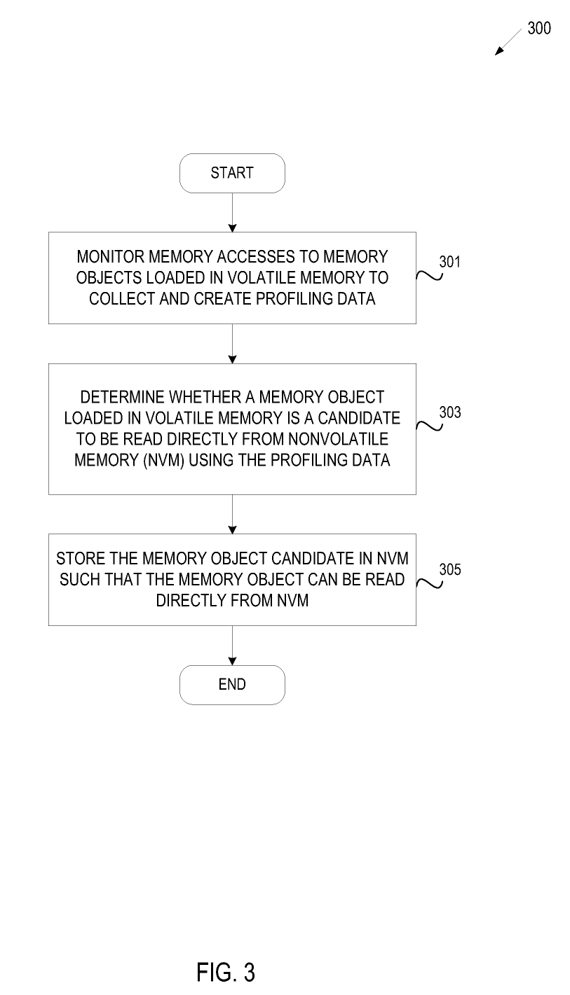

FIG. 3 is a flow diagram of one embodiment of a method for identifying a memory object stored in volatile memory as a candidate to be read directly from nonvolatile memory. The method may be performed by processing logic that may comprise hardware (e.g., circuitry, dedicated logic, etc.), software (such as run on a general purpose computer system or a dedicated machine), or a combination of both. For one embodiment, processing logic resides in a memory profiling system 100 of FIG. 1.

At block 301, processing logic monitors memory accesses to memory objects loaded in volatile memory (e.g., DRAM) to collect and create profiling data. Profiling data can include the address of the memory object, how often an object is loaded in DRAM, and how often the object is written to. At block 303, processing logic uses the profiling data to determine whether a memory object is a candidate to be transitioned to and read directly from nonvolatile memory. At block 305, processing logic stores the memory object candidates as uncompressed memory objects in nonvolatile memory such that a memory object can be read directly from the nonvolatile memory.

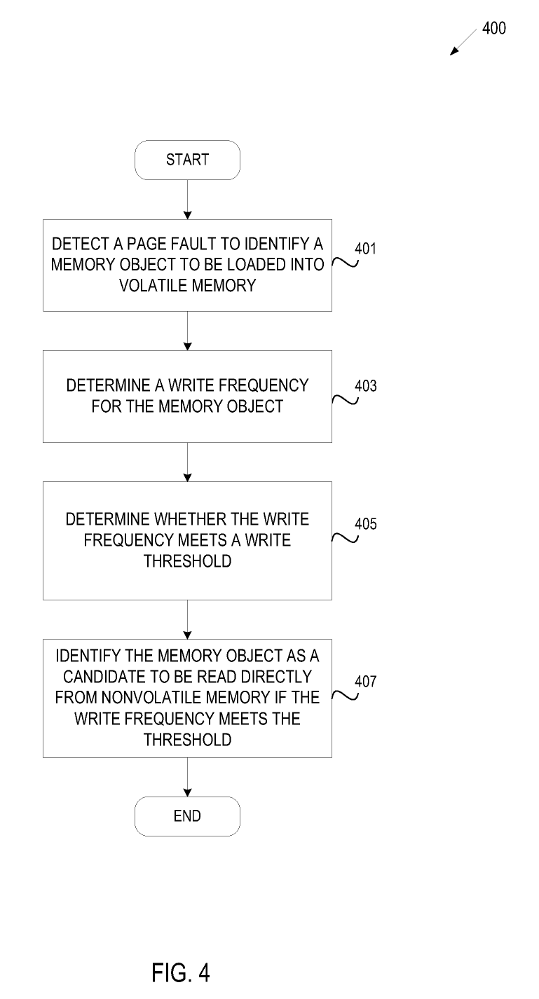

FIG. 4 is another flow diagram of one embodiment of a method for determining whether a memory object is a candidate to be stored in and read directly from nonvolatile memory. The method may be performed by processing logic that may comprise hardware (e.g., circuitry, dedicated logic, etc.), software (such as run on a general purpose computer system or a dedicated machine), or a combination of both. For one embodiment, processing logic resides in a memory profiling system 100 of FIG. 1.

At block 401, processing logic detects a page fault and uses the page fault to identify the memory object to be loaded in DRAM. Processing logic detects a page fault by monitoring the activity of a page table for a period of time or profiling time. The profiling time may be a pre-defined time period or a user-defined time period. For example, an OEM may run tests for a two-hour time period and therefore, processing logic monitors a page table's activity for a two-hour time period. Processing logic can identify the object by an address and an access type (e.g., read or write).

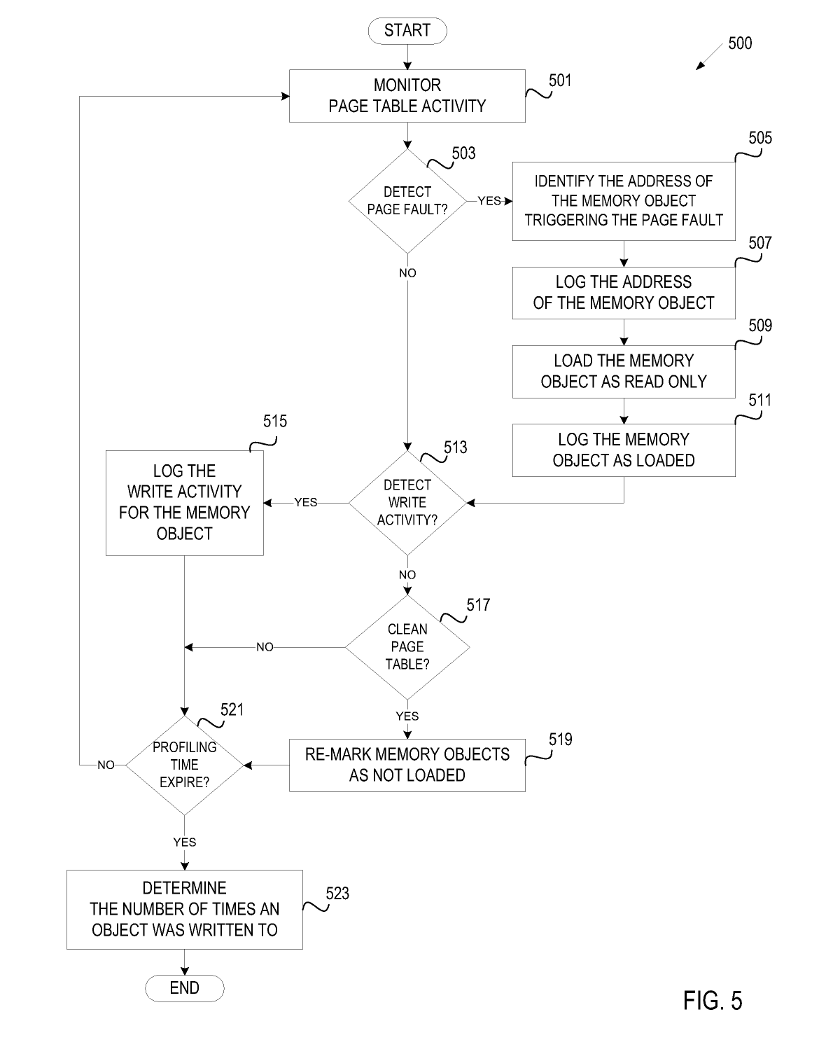

At block 403, processing logic determines a write frequency for the memory object. The write frequency is the number of times a memory object is written to. Write frequency is discussed in greater detail below in conjunction with FIG. 5. At block 405, processing logic determines whether the write frequency meets a write threshold. FIG. 6 describes meeting the write threshold in greater detail below. At block 407, processing logic identifies a memory object as a candidate to be read directly from nonvolatile memory based on whether the write frequency meets the write threshold.

FIG. 5 is flow diagram of one embodiment of a method 500 for determining a write frequency for a memory object. The method may be performed by processing logic that may comprise hardware (e.g., circuitry, dedicated logic, etc.), software (such as run on a general purpose computer system or a dedicated machine), or a combination of both. For one embodiment, processing logic resides in a memory profiling system 100 of FIG. 1.

At block 501, processing logic monitors a page table's activity. At block 503, processing logic determines whether there is a page fault. If processing logic detects a page fault (block 503), processing logic identifies the address of the memory object triggering the page fault at block 505. At block 507, processing logic logs the address of the memory object. Alternatively, processing logic can determine the memory object was previously loaded and therefore already logged. At block 509, processing logic loads the memory object as read only and logs the memory object as loaded at block 511.

If processing logic does not detect a page fault (block 503), processing logic determines whether a memory object is written to at block 513. If processing logic detects write activity (block 513), processing logic logs the write activity for the memory object (block 515) and determines if the profiling time period has expired at block 521.

At block 513, if processing does not detect write activity, processing logic determine whether to clean the page table at block 517. Processing logic determines whether to clean the page table entries based on whether a user-defined time period has elapsed. For example, an OEM can define processing logic to clean the page table entries every 10 ms. If processing logic determines the user-defined time period has elapsed (block 517), processing logic re-marks the memory objects currently loaded in DRAM as not loaded at block 519, thus forcing the memory objects to be reloaded. If processing logic determines the user-defined time period has not elapsed (block 517), processing logic determines whether the profiling time period has expired at block 521.

At block 521, if processing logic determines the profiling time period has not expired, processing logic returns to block 501 to continue monitoring the page table activity. If processing logic determines the profiling time period has expired (block 521), processing logic determines the number of times the memory object was written to using the logged data at block 523.

FIG. 6 is flow diagram of one embodiment of a method 600 for determining whether a memory object meets a write threshold to be stored in and read directly from nonvolatile memory. The method may be performed by processing logic that may comprise hardware (e.g., circuitry, dedicated logic, etc.), software (such as run on a general purpose computer system or a dedicated machine), or a combination of both. For one embodiment, processing logic resides in a memory profiling system 100 of FIG. 1.

At block 601, processing logic determines whether the memory object's write frequency is less than or equal to a PCM threshold. The PCM threshold is the current write performance rate of a PCM technology. For example, the current write performance of PCM is a rate of 10 MB/s. However, as technology develops, the future write performance of PCM may be, for example, a rate of 40 MB/s. If processing logic determines that the memory object's write frequency is not less than or equal to the PCM threshold (block 601), processing logic identifies the memory object is not a candidate for nonvolatile memory (block 603) and the method 600 completes.

Tables 2A to 2C illustrate examples of thresholds for each memory access type.

TABLE 2A

| | Memory Access |
|---|---|
| Memory Object Write Rate | Type |
| 0 MB/s | Read only |
| >0 MB/s to [Current NOR Write Performance Rate] | Read - write rarely |
| [>Current NOR Write Performance Rate] to | Read - write |
| [Current PCM Write Performance Rate] | |
| [>Current PCM Write Performance Rate] to | Read - write |
| [Current DRAM Write Performance Rate] | frequently |

For instance, Table 2A illustrates that for a system that includes NOR, PCM, and DRAM technology, the current write performance parameters for NOR, PCM, and DRAM provide the reference points for the terms ‘rarely’ and ‘frequently.’ Therefore, if the write performance parameter of a technology changes, the terms ‘rarely’ and ‘frequently’ adjust according to the change. Table 2B below illustrates the current write performance rates used as references for defining memory access types for a system that includes NOR, PCM, and DRAM technology.

TABLE 2B

| Memory Object | | Candidate | Candidate |
|---|---|---|---|
| Write Rate | Memory Access Type | for NOR? | for PCM? |
| 0 MB/s | Read only | YES | YES |
| >0 MB/s to 1 MB/s | Read - write rarely | YES | YES |
| >1 MB/s to 10 MB/s | Read - write | NO | YES |
| >10 MB/s to 100 MB/s | Read - write frequently | NO | NO |

As seen in Table 2B, the current write performance of NOR is a rate of 1 MB/s and provides a reference point for the term ‘rarely.’ The current write performance of PCM is a rate of 10 MB/s and provides a reference point for the ‘read-write’ memory access type. The current write performance of DRAM is a rate of 100 MB/s and provides a reference point for the term ‘frequently.’ Therefore, if a memory object has a write frequency of 1 MB/s or lower, the object is a ‘read-write rarely’ memory access type, if an object has a write frequency of 5 MB/s, the object is a ‘read-write’ memory access type, and if an object has a write frequency of 30 MB/s, the object is a ‘read-write frequently’ memory access type.

Table 2C below illustrates an example where the write performance parameter for the PCM technology has changed to a rate of 40 MB/s. In this example, if an object has a write frequency of 30 MB/s, the object is now a ‘read-write’ memory access type, rather than a ‘read-write frequently’ memory access type as defined above by Table 2B.

TABLE 2C

| Memory Object | | Candidate | Candidate |
|---|---|---|---|
| Write Rate | Memory Access Type | for NOR? | for PCM? |
| 0 MB/s | Read only | YES | YES |
| >0 MB/s to 1 MB/s | Read - write rarely | YES | YES |
| >1 MB/s to 40 MB/s | Read - write | NO | YES |
| >40 MB/s to 100 MB/s | Read - write frequently | NO | NO |

Referring back to FIG. 6, if processing logic determines that the memory object's write frequency is less than or equal to the PCM threshold (block 601), processing logic determines whether the memory object's write frequency is less than or equal to a NOR threshold at block 605. The NOR threshold is the current write performance rate of a NOR technology. For example, the current write performance of NOR is a rate of 1 MB/s. If processing logic determines that the memory object's write frequency is not less than or equal to the NOR threshold (block 605), processing logic identifies the memory object is a candidate to be stored in and directly read from PCM memory at block 607. If processing logic determines that the memory object's write frequency is less than or equal to the NOR threshold (block 605), processing logic identifies the memory object is a candidate to be stored in and directly read from PCM memory and NOR memory at block 609.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. All of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “monitoring,” “storing,” “detecting,” “using,” “identifying,” “marking,” “receiving,” “loading,” “reconfiguring,” “formatting,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

Various general purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. A variety of programming languages may be used to implement the teachings of the invention as described herein. In addition, it should be understood that operations, capabilities, and features described herein may be implemented with any combination of hardware (discrete or integrated circuits) and software.

In the foregoing specification, reference has been made to specific embodiments of this invention. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising:
monitoring memory accesses to a memory object in volatile memory to collect and create profiling data;
determining whether the memory object in volatile memory is a candidate to be stored and read directly from nonvolatile memory using the profiling data; and
storing the memory object candidate in nonvolatile memory such that the memory object is read directly from nonvolatile memory.

2. The method of claim 1, wherein monitoring memory accesses to a memory object in volatile memory comprises:
monitoring activity of a page table;
detecting a page fault in the page table activity; and
using the page fault to identify a memory object to be loaded into volatile memory.

3. The method of claim 1, wherein determining whether the memory object in volatile memory is a candidate to be stored and read directly from nonvolatile memory comprises:
determining a write frequency for the memory object, wherein the write frequency is a number of times the memory object is written to during a profiling time period;
determining whether the write frequency meets a write threshold; and
identifying the memory object is a candidate to be read directly from nonvolatile memory if the write frequency meets the write threshold.

4. The method of claim 3, wherein determining whether the write frequency meets the write threshold comprises:
determining whether the write frequency is equal to or less than a PCM threshold, wherein the PCM threshold is the current write performance rate of a PCM technology; and
identifying the memory object is a candidate to be read directly from nonvolatile memory if the write frequency is equal to or less than the PCM threshold.

5. The method of claim 4, further comprising:
determining whether the write frequency exceeds a NOR threshold, wherein the first NOR threshold is the current write performance rate of a NOR memory technology; and
identifying the memory object is a candidate to be read directly from PCM memory if the write frequency exceeds the NOR threshold.

6. The method of claim 5, further comprising:
identifying the memory object is a candidate to be read directly from at least one of NOR memory and PCM memory if the write frequency does not exceed the NOR threshold.

7. The method of claim 3, wherein determining a write frequency for the memory object comprises:
loading the memory object as a read only memory object;
monitoring attempts to write to the memory object for a period of time, wherein the period of time is a user-defined time period; and
determining a number of times the memory object is written to during the period of time.

8. The method of claim 1, wherein storing the memory object candidate in nonvolatile memory such that the memory object is read directly from nonvolatile memory comprises:
reconfiguring a system memory based on the profiling data, wherein reconfiguring the system memory includes decompressing the memory object in nonvolatile memory and storing the memory object as an uncompressed memory object in nonvolatile memory.

9. The method of claim 1, wherein storing the memory object candidate in nonvolatile memory such that the memory object is read directly from nonvolatile memory comprises:
formatting the profiling data in a format used to rebuild a system memory; and
providing the formatted data to rebuild the system memory.

10. A machine-accessible storage medium that provides instructions that, if executed by a machine, will cause the machine to perform operations, comprising:
monitoring memory accesses to a memory object in volatile memory to collect and create profiling data;
determining whether the memory object in volatile memory is a candidate to be stored and read directly from nonvolatile memory using the profiling data; and
storing the memory object candidate in nonvolatile memory such that the memory object is read directly from nonvolatile memory.

11. The machine-accessible storage medium of claim 10, wherein monitoring memory accesses to a memory object in volatile memory comprises:
monitoring activity of a page table;
detecting a page fault in the page table activity; and
using the page fault to identify a memory object to be loaded into volatile memory.

12. The machine-accessible storage medium of claim 10, wherein determining whether the memory object in volatile memory is a candidate to be stored and read directly from nonvolatile memory comprises:
determining a write frequency for the memory object, wherein the write frequency is a number of times the memory object is written to during a profiling time period;
determining whether the write frequency meets a write threshold; and
identifying a memory object is a candidate to be read directly from nonvolatile memory if the write frequency meets the write threshold.

13. The machine-accessible storage medium of claim 12, wherein determining whether the write frequency meets the write threshold comprises:
determining whether the write frequency is equal to or less than a PCM threshold, wherein the PCM threshold is the current write performance rate of a PCM technology; and
identifying the memory object is a candidate to be read directly from nonvolatile memory if the write frequency is equal to or less than the PCM threshold.

14. The machine-accessible storage medium of claim 13, further comprising:
determining whether the write frequency exceeds a NOR threshold, wherein the first NOR threshold is the current write performance rate of a NOR memory technology; and
identifying the memory object is a candidate to be read directly from PCM memory if the write frequency exceeds the NOR threshold.

15. The machine-accessible storage medium of claim 14, further comprising:
identifying the memory object is a candidate to be read directly from at least one of NOR memory and PCM memory if the write frequency does not exceed the NOR threshold.

16. The machine-accessible storage medium of claim 12, wherein determining a write frequency for the memory object comprises:
loading the memory object as a read only memory object;
monitoring attempts to write to the memory object for a period of time, wherein the period of time is a user-defined time period; and
determining a number of times the memory object is written to during the period of time.

17. The machine-accessible storage medium of claim 12, wherein storing the memory object candidate in nonvolatile memory such that the memory object is read directly from nonvolatile memory comprises:
reconfiguring a system memory based on the profiling data, wherein reconfiguring the system memory includes decompressing the memory object in nonvolatile memory and storing the memory object as an uncompressed memory object in nonvolatile memory.

18. A system comprising:
a processor;
a nonvolatile memory coupled to the processor; and
a random access memory coupled to the processor to transition a memory object stored in the random access memory to nonvolatile memory, wherein the transitioned memory object is accessed directly from the nonvolatile memory.

19. The system of claim 18, further comprising:
a memory management unit associated with the processor to generate a page fault if a memory object is not available in the random access memory, wherein the random access memory uses the page fault to identity the one or more memory objects to transition to the nonvolatile memory.

20. The system of claim 18, wherein the random access memory is further to reconfigure a system memory map to transition the memory object stored in the random access memory to nonvolatile memory.
